(19) United States
(12) Patent Application Publication
(10) Pub. No.: US 2021/0182859 A1
(43) Pub. Date: Jun. 17, 2021

(54) System And Method For Modifying An Existing Anti-Money Laundering Rule By Reducing False Alerts

(71) Applicant: Accenture Global Solutions Limited, Dublin (IE)

(72) Inventors: Prasanna Srinivasa Rao, Bengaluru (IN); Sailatha Karthikeyan, Bangalore (IN); Parag Bapu Rane, Thane (IN); Rashmi V. Nair, Chennai (IN); Manju S. Nair, Chennai (IN)

(21) Appl. No.: 16/718,136

(22) Filed: Dec. 17, 2019

(51) Int. Cl. G06Q 20/40; G06N 20/00

(52) U.S. Cl. CPC G06Q 20/4016; G06N 20/00

(57) ABSTRACT

A system and method for modifying existing rules of an existing anti-money laundering software system to reduce false alerts is disclosed. The system and method can find relationships amongst transactions and actors involved in transactions by using knowledge graphs and techniques that can help determine actors' likelihood of money laundering. Artificial intelligence may be used to: augment missing data at various stages throughout the disclosed method, help find new thresholds for existing rules of an anti-money laundering system, and test the new thresholds before making recommendations for thresholds. The system and method can gather more context about transactions and actors (e.g., account holders) by providing a way for entities, such as financial institutions, to share transaction data, non-transaction data, analyses based on transaction data, and historical alerts through private blockchain.

### TECHNICAL FIELD

The present disclosure generally relates to anti-money laundering (AML) software. More specifically, the present disclosure generally relates to a system and method for reducing false alerts generated by AML software. Even more specifically, the present disclosure generally relates to modifying an existing AML rule to reduce false alerts.

### BACKGROUND

Presently, financial institutions have a duty to comply with AML regulations by monitoring the transactional or non-transactional activities of their customers and by reporting any suspicious activities to regulatory bodies. Suspicious activities can indicate that transactions are related to criminal activity such as tax evasion, terrorist financing, human trafficking, extortion, drug dealing, and embezzlement. AML software systems exist to help financial institutions spot suspicious activities. Existing AML software systems have a set of rules defined in terms of transaction threshold amounts and count. The systems use these rules to generate an alert when an instance of money laundering is suspected.

Financial institutions send a suspicious activity report (SAR) to a regulatory body when suspicious activities are suspected. Typically, when a transaction first draws attention as an unusual activity possibly indicating a suspicious activity, and an alert is assigned to an analyst who investigates whether the alert should become a case. The analyst clears the alert if the analyst determines that the alert is a false positive. The analyst creates a case for the alert if the analyst determines an investigation needs to be done to examine whether the alert should be escalated to a SAR. The analyst may directly determine that an alert should be escalated to a SAR without raising the alert to the case status first. Similarly, the analyst may determine that a case should be demoted to a false positive upon finding that no suspicious activity is present.

Because of the large numbers of transactions monitored and the complex networks involved in money laundering, many existing AML systems are prone to issuing false positive alerts and for also failing to catch instances of money laundering.

There is a need in the art for a system and method that addresses the shortcomings discussed above.

### SUMMARY

The present system and method solve the problems discussed above by analyzing transaction data, non-transaction data, and historical alerts to determine a recommendation for modifying an existing AML rule to reduce the number of false alerts. The false alerts in this case could be false positive alerts or missed (or negative) alerts. The system and method can find relationships amongst transactions and actors involved in transactions by using knowledge graphs and techniques that can help determine actors' likelihood of money laundering and the proximity of the actors to hopping transactions. Artificial intelligence may be used to augment missing data at various stages throughout the disclosed method.

It can be difficult for a financial institution to gather information about transactions that happen outside of that particular financial institution and about account holders from other financial institutions. The system and method can help with gathering more context about transactions and actors (e.g., account holders) by providing a way for entities, such as financial institutions, to share transaction data, non-transaction data, analyses based on transaction data, and historical alerts through private blockchain.

In one aspect, the disclosure provides a method for modifying an existing anti-money laundering rule of an existing anti-money laundering system to reduce false alerts. The method may include building a knowledge graph with a first set of transaction data related to a first set of transactions each involving a payor and a payee, a first set of non-transaction data related to at least one payor and/or at least one payee involved in at least one of the first set of transactions, and a plurality of historical alerts each corresponding to a transaction of the first set of transactions. The method may further include using machine learning to determine overall risk scores for account holders based on the first set of transaction data and the first set of non-transaction data, wherein the account holders are payors and/or payees involved in the first set of transactions. The method may further include sharing the overall risk scores, the first set of transaction data, and the first set of non-transaction data with at least one entity through private blockchain. The method may further include from the at least one entity through private blockchain, receiving a second set of transaction data related to a second set of transactions each involving a payor and a payee and a second set of non-transaction data related to at least one payor and/or at least one payee involved in at least one of the second set of transactions. The method may further include updating the knowledge graph with the second set of transaction data and the second set of non-transaction data. The method may further include using the updated knowledge graph to identify hopping transactions in which money is transferred from an initial payor to a final payee through at least one intermediary transaction involving different financial institutions and/or actors other than the first payor and the first payee, the actors acting as payors and/or payees in the intermediary transactions. The method may further include for each account holder, calculating a degree of separation between the account holder and an initial payor, final payee, or actor involved in at least one hopping transaction. The method may further include for each account holder, determining a context score based on the account holder's overall risk score and degree of separation.

The method may further include using the context scores, historical alert data, one or both of the first and second transaction data, and one or both of the first and second non-transaction data to calculate the false positive likelihood of alerts generated by the existing anti-money laundering system.

The method may further include using the context scores, historical alert data, one or both of the first and second transaction data, and one or both of the first and second non-transaction data to perform a key driver analysis to determine factors impacting the false positive likelihood of the alerts.

The method may further include using the results of the key driver analysis with a decision tree method to create decision rules and to determine new threshold values for the existing anti-money laundering rule.

The method may further include performing a gap analysis using a what-if simulation with the new threshold values and the decision rules to determine difference between performance of existing anti-money laundering rules and anti-money laundering rules modified with the new threshold values.

The method may further include using reinforcement learning determine a recommendation for modifying the existing anti-money laundering rule. The steps may be performed in any order.

In yet another aspect, the disclosure provides a non-transitory computer-readable medium storing software that may comprise instructions executable by one or more computers which, upon such execution, cause the one or more computers to: (1) build a knowledge graph with a first set of transaction data related to a first set of transactions each involving a payor and a payee, a first set of non-transaction data related to at least one payor and/or at least one payee involved in at least one of the first set of transactions, and a plurality of historical alerts each corresponding to a transaction of the first set of transactions; (2) use machine learning to determine overall risk scores for account holders based on the first set of transaction data and the first set of non-transaction data, wherein the account holders are payors and/or payees involved in the first set of transactions; (3) share the overall risk scores, the first set of transaction data, and the first set of non-transaction data with at least one entity through private blockchain; (4) from the at least one entity through private blockchain, receive a second set of transaction data related to a second set of transactions each involving a payor and a payee and a second set of non-transaction data related to at least one payor and/or at least one payee involved in at least one of the second set of transactions; (5) update the knowledge graph with the second set of transaction data and the second set of non-transaction data; (6) use the updated knowledge graph to identify hopping transactions in which money is transferred from an initial payor to a final payee through at least one intermediary transaction involving different financial institutions and/or actors other than the first payor and the first payee, the actors acting as payors and/or payees in the intermediary transactions; (7) for each account holder, calculate a degree of separation between the account holder and an initial payor, final payee, or actor involved in at least one hopping transaction; (8) for each account holder, determine a context score based on the account holder's overall risk score and degree of separation; (9) use the context scores, historical alert data, one or both of the first and second transaction data, and one or both of the first and second non-transaction data to calculate the false positive likelihood of alerts generated by the existing anti-money laundering system; (10) use the context scores, historical alert data, one or both of the first and second transaction data, and one or both of the first and second non-transaction data to perform a key driver analysis to determine factors impacting the false positive likelihood of the alerts; (11) use the results of the key driver analysis with a decision tree method to create decision rules and to determine new threshold values for the existing anti-money laundering rule; (12) perform a gap analysis using a what-if simulation with the new threshold values and the decision rules to determine difference between performance of existing anti-money laundering rules and anti-money laundering rules modified with the new threshold values; and (13) use reinforcement learning determine a recommendation for modifying the existing anti-money laundering rule. These steps may be performed in any order.

In yet another aspect, the disclosure provides a system for modifying an existing rules of an existing AML system to reduce false alerts, which comprises one or more computers and one or more storage devices storing instructions that may be operable, when executed by the one or more computers, to cause the one or more computers to: (1) build a knowledge graph with a first set of transaction data related to a first set of transactions each involving a payor and a payee, a first set of non-transaction data related to at least one payor and/or at least one payee involved in at least one of the first set of transactions, and a plurality of historical alerts each corresponding to a transaction of the first set of transactions; (2) use machine learning to determine overall risk scores for account holders based on the first set of transaction data and the first set of non-transaction data, wherein the account holders are payors and/or payees involved in the first set of transactions; (3) share the overall risk scores, the first set of transaction data, and the first set of non-transaction data with at least one entity through private blockchain; (4) from the at least one entity through private blockchain, receive a second set of transaction data related to a second set of transactions each involving a payor and a payee and a second set of non-transaction data related to at least one payor and/or at least one payee involved in at least one of the second set of transactions; (5) update the knowledge graph with the second set of transaction data and the second set of non-transaction data; (6) use the updated knowledge graph to identify hopping transactions in which money is transferred from an initial payor to a final payee through at least one intermediary transaction involving different financial institutions and/or actors other than the first payor and the first payee, the actors acting as payors and/or payees in the intermediary transactions; (7) for each account holder, calculate a degree of separation between the account holder and an initial payor, final payee, or actor involved in at least one hopping transaction; (8) for each account holder, determine a context score based on the account holder's overall risk score and degree of separation; (9) use the context scores, historical alert data, one or both of the first and second transaction data, and one or both of the first and second non-transaction data to calculate the false positive likelihood of alerts generated by the existing anti-money laundering system; (10) use the context scores, historical alert data, one or both of the first and second transaction data, and one or both of the first and second non-transaction data to perform a key driver analysis to determine factors impacting the false positive likelihood of the alerts; (11) use the results of the key driver analysis with a decision tree method to create decision rules and to determine new threshold values for the existing anti-money laundering rule; (12) perform a gap analysis using a what-if simulation with the new threshold values and the decision rules to determine difference between performance of existing anti-money laundering rules and anti-money laundering rules modified with the new threshold values; and (13) use reinforcement learning determine a recommendation for modifying the existing anti-money laundering rule. These steps may be performed in any order.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 shows a system for modifying an existing AML rule by reducing false alerts according to an embodiment.

FIG. 2 shows an architecture of a knowledge graph infrastructure according to an embodiment.

FIG. 3 shows the process of calculating a risk score for account holders according to an embodiment.

FIG. 4 illustrates how missing information may be imputed using a graph convolutional network according to an embodiment.

FIG. 5 shows an example of a hopping transaction.

FIG. 6 shows the overall inputs and outputs related to finding and testing new thresholds for existing AML rules according to an embodiment.

FIG. 7 shows inputting an analytical base table into a gradient boosting framework and outputting false positive likelihood output according to an embodiment.

FIG. 8 shows the feature importance resulting from the key driver analysis according to an embodiment.

FIG. 9 shows a first decision tree based on transaction amount and a second decision tree based on transaction type according to an embodiment.

FIG. 10 shows a directed acyclic graph created using Bayesian scoring of constraints according to an embodiment.

FIG. 11 shows the general flow of analysis that leads to a recommendation for threshold values according to an embodiment.

FIG. 12 illustrates results of a what-if simulation according to an embodiment.

FIGS. 13A, 13B, and 13C show a method for modifying an existing AML rule by reducing false alerts according to an embodiment.

### DESCRIPTION OF EMBODIMENTS

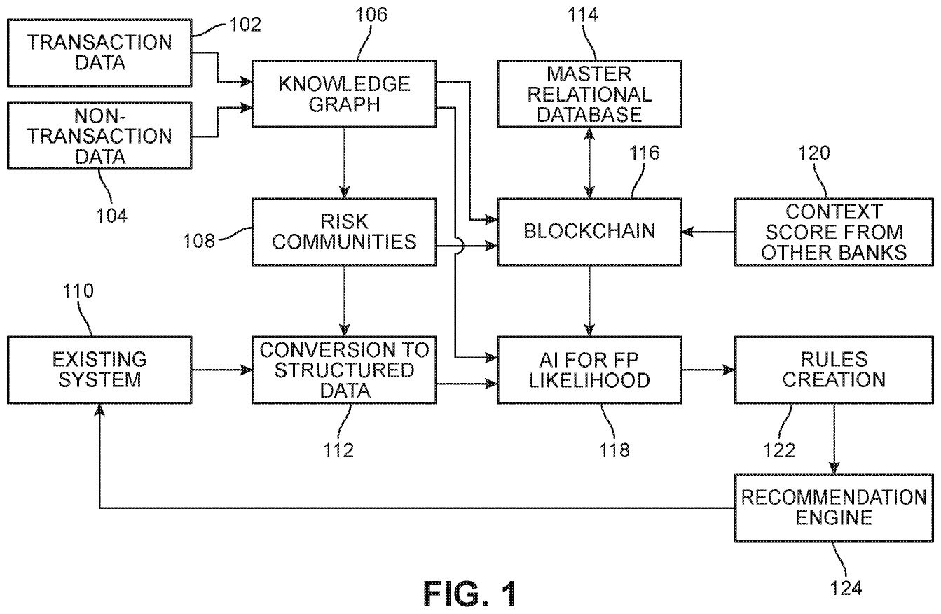

A system and method for modifying an existing AML rule by reducing false alerts is disclosed. Within the system, data is transformed, analyzed, and mined at different points to ultimately determine a recommendation to modify an existing rule of an AML software system. FIG. 1 shows a system for modifying an existing AML rule by reducing false alerts according to an embodiment. In some embodiments, transaction data and non-transaction data related to account holders in at least one financial institution may be used to build a knowledge graph. For example, transaction data 102 and non-transaction data 104 is used to build a knowledge graph 106. A knowledge graph can enhance the understanding of the relationships underlying transaction and non-transaction data and can help with analyses used to determine a recommendation to modify an existing rule of an AML software system. In addition to efficiently storing relationships, knowledge graphs can efficiently be updated with new information without excessive computational downtime.

The transaction data inputted to the knowledge graph may come from transactions a particular financial institution facilitates and/or may be obtained from other sources. In some embodiments, transaction data may include the identities of the account holder acting as a payor and the account holder acting as a payee in a transaction, as well as the date of the transaction, the financial institutions involved, and the amount of the transaction. Non-transaction data may include many different types of information related to actors and/or financial institutions involved in transactions. For example, a financial institution may have non-transaction data in the form of profile information about their account holders, such as their account holders' annual salary, age, gender, residence, occupation, and/or credit rating if the account holder is an individual. In another example, social media may be mined for non-transaction data. In such an example, named-entity recognition (NER) of social media data and a transaction description may be used to add more data to the knowledge graph. Venmo, which is a mobile payment service, could be considered a financial institution in the context of this disclosure. Additionally, Venmo includes a social media component where account holders can share transaction information. For example, in Venmo, a transaction may be posted showing the payor paid a payee. In another example, a social media website may display a user's post with a text string describing a transaction, such as “User1 wired transfer to User2.” In some embodiments, NER may be used to extract the relationship between User1 and User2.

The data in the knowledge graph may be updated at different points throughout the disclosed method. For example, the knowledge graph may be updated with the results of analyses and/or new data related to new transactions and/or new account holders. In some embodiments, the transaction and non-transaction data may be obtained by and/or possessed by a financial institution.

In some embodiments, risk communities containing account holders with similar behaviors may be identified within the knowledge graph. For example, risk communities 108 containing account holders with similar behaviors may be identified within knowledge graph 106. As discussed below in more detail, in some embodiments, techniques, such as bipartite adjacency matrices, bipartite graphs, and the Girvan-Newman algorithm may be used to find risk communities within the knowledge graph.

The risk communities and information from the knowledge graph may be converted into structured data used for further analyses. For example, risk communities 108 and data from knowledge graph 106 may be converted to structured data 112. In some embodiments, information from the knowledge graph and the risk communities, in the form of structured data, may be used in an analysis to determine a context score for one or more account holders. The context score may be used to illuminate the circumstances surrounding transactions. In particular, the context score can help identify whether a transaction is actually part of a money laundering activity. The context score of a transaction is based on a risk score calculated for an account holder involved in the transaction (which is based on transaction and non-transaction data related to the account holder), as well as the account holder's connection to a hopping transaction. A risk score is a score indicating an account holder's likelihood of money laundering. A hopping transaction is a type of transaction that is often used to obscure who money is being paid from and whom money is being paid to. The calculation of both the risk score and an account holder's connection to a hopping transaction is discussed in more detail below.

Obtaining information from more financial institutions can provide additional information about other actors in transactions, which can help with determining behavior patterns of these actors and can help with identifying hopping transactions. Thus, the disclosed system and method may include sharing information amongst financial institutions via private blockchain. For example, in some embodiments, the risk communities and information from the knowledge graph may be shared with one or more financial institutions through private blockchain. For example, risk communities 108 and data from knowledge graph 106 may be shared through blockchain 116. Additionally, a master relational database 114 may be used to store aggregated information from multiple sources that may be shared with multiple financial institutions through blockchain. For example, information shared through blockchain 116 may be stored and retrieved from master relational database 114.

In some embodiments, to help with analysis of transactions and/or existing rules of an existing AML system, information from an existing AML system may be sent to conversion to structured data. For example, information from an existing AML system 110 may be sent to conversion to structured data 112.

The structured data and information from an existing AML system, as well as information from the knowledge graph may be used by an artificial intelligence model that can determine a false positive likelihood of an alert issued by the existing AML system. For example, structured data 112 and information from an existing AML system 110, as well as information from knowledge graph 106 may be used by an artificial intelligence model 118. In some embodiments, the false positive likelihood result from the artificial intelligence model may be enhanced by information shared from multiple sources (e.g., other financial institutions) through private blockchain. For example, context scores determined at other financial institutions 120 may be shared by blockchain 116 with artificial intelligence model 118.

In some embodiments, the false positive likelihood results (which may be represented in probabilistic format) from the artificial intelligence model may analyzed using decision trees to determine decision rules and thresholds for the existing rules of the existing AML system. For example, the results from artificial intelligence model 118 may be analyzed to create rules 122. In some embodiments, a recommendation engine 124 may use the determined decision rules and thresholds for the existing rules to compare the existing rules using the thresholds with the existing rules with their initial thresholds. For example, the rules and thresholds from rules creation 112 may be used by recommendation engine 124. The recommendation engine may use the results of the comparison to determine a recommendation to modify an existing rule of an AML software system. The recommendation engine may send the recommendation to the existing system. For example, recommendation engine 124 sends the recommendation to existing system 110.

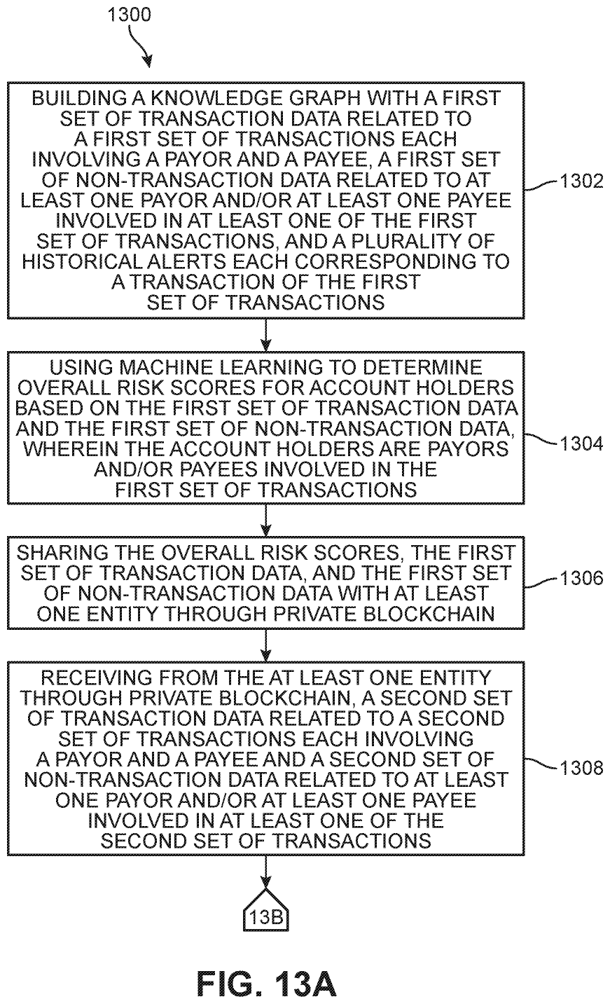

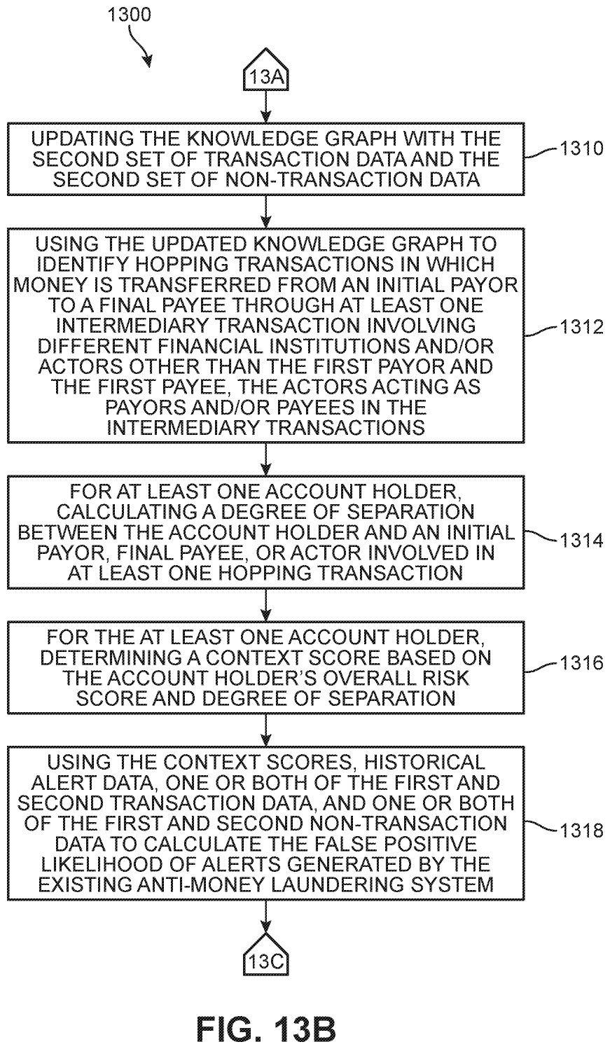

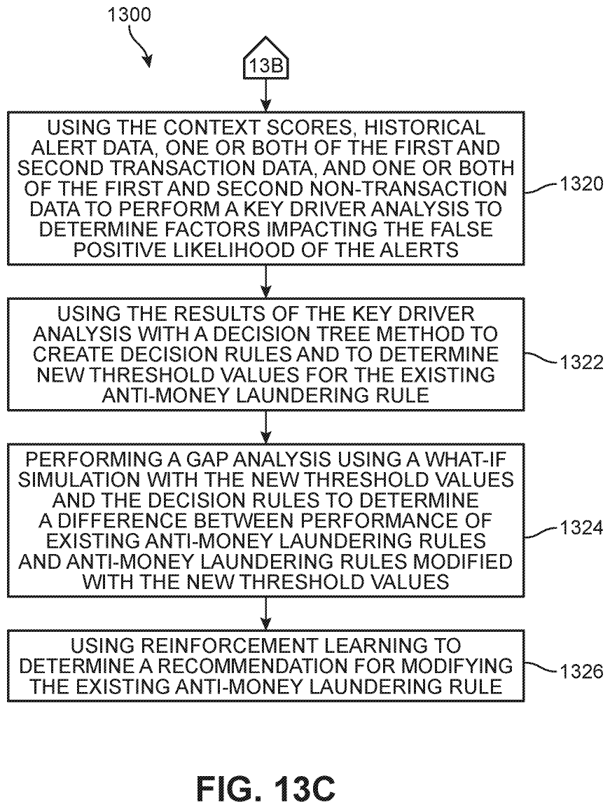

FIGS. 13A, 13B, and 13C show a method for modifying an existing AML rule by reducing false alerts 1300 (or method 1300) according to an embodiment. Method 1300 includes building a knowledge graph with a first set of transaction data related to a first set of transactions each involving a payor and a payee, a first set of non-transaction data related to at least one payor and/or at least one payee involved in at least one of the first set of transactions, and a plurality of historical alerts each corresponding to a transaction of the first set of transactions (operation 1302). In some embodiments, the first set of transaction data and non-transaction data may be obtained by a first financial institution. Then, at later points in the method, other financial institutions may provide further information that the knowledge graph is updated with.

In some embodiments, transaction data may include information such as record numbers, reference numbers, account numbers, Bnumbers, Bnames, customer numbers, transaction dates, transaction codes, and/or transaction amounts. In some embodiments, this information may be provided as fields within tables, and then may be converted to knowledge graph form. In some embodiments, the information held in the knowledge graph may be pre-processed to redact or replace sensitive identification information with tokens used as placeholders to protect sensitive information. For example, a Bname of a recipient may be changed to a party tokenizing party number, e.g. “Party0006.”

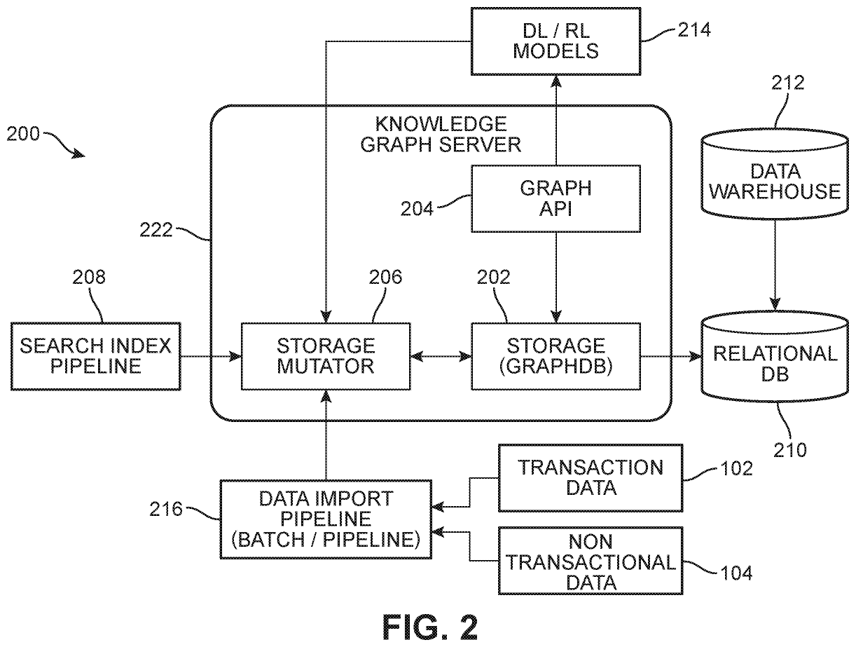

As mentioned above, the system and method may begin with building a knowledge graph. FIG. 2 shows an architecture of a knowledge graph infrastructure 200 according to an embodiment. Knowledge graph infrastructure 200 includes a knowledge graph server 222 having a graph storage 202, a graph application program interface (graph API) 204, and a storage mutator 206. Graph API 204 provides graph query services. Knowledge graph infrastructure 200 includes a search index pipeline 208, a relational database 210, a data warehouse 212, a data import pipeline 216, and deep learning and/or reinforcement learning models 214. Transaction data 102 and non-transaction 104 may be inputted into data import pipeline 216, which is then inputted into storage mutator 206.

A graphical database (e.g., Neo4j) may be used to store the knowledge graph and to perform create, read, update, and delete (CRUD) operations using cypher queries on nodes (e.g., accounts or account holders) and edges (relationships). Specific types of edges (e.g., transaction amount, number of transactions, transaction country, social media features) may be fetched from the knowledge graph.

The method for modifying an existing AML rule by reducing false alerts may include determining an overall risk score for account holders. For example, method 1300 includes using machine learning to determine overall risk scores for account holders based on the first set of transaction data and the first set of non-transaction data, wherein the account holders are payors and/or payees involved in the first set of transactions (operation 1304). As mentioned above, the risk score of an account holder, which is partially based on a risk score of an account holder, indicates the account holder's likelihood of money laundering. The risk score may be calculated based on transaction data and non-transaction data from a bank in which the account holder has their account.

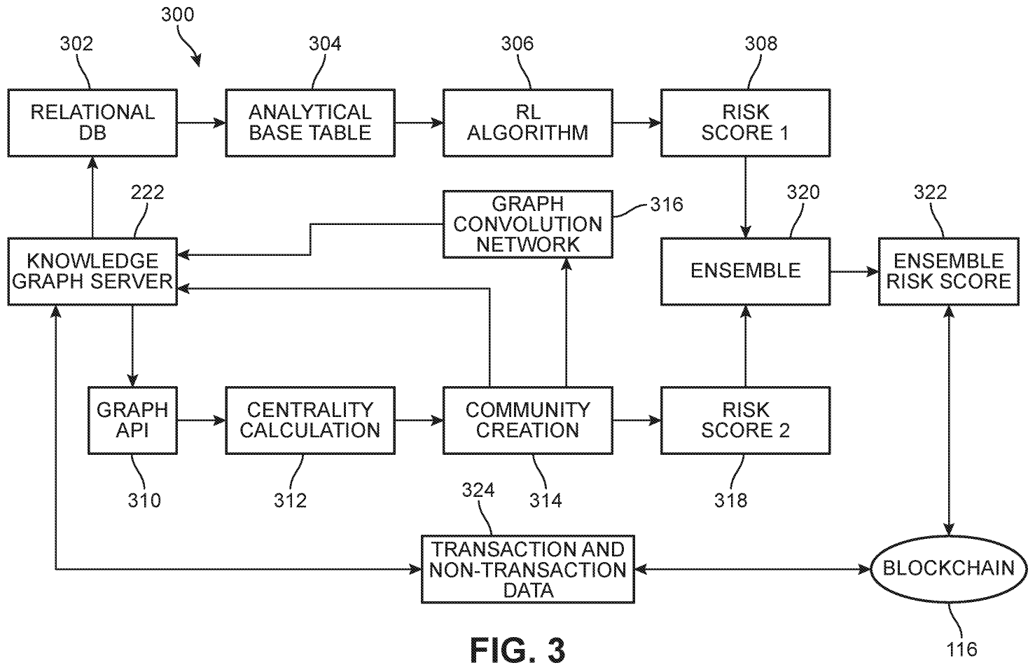

FIG. 3 shows the process of calculating a risk score for account holders 300 (or process 300) according to an embodiment. The account holders in process 300 may include individuals, companies, and/or entities who have bank accounts in their name, etc. To ensure that processes used to calculate risk scores are accurate (e.g., to avoid overfitting of models), ensemble machine learning is used to calculate risk scores. Communities of actors (payors and/or payees involved in transactions) having similar behavior patterns are identified within the knowledge graph. A first set of risk scores are calculated for these communities in a first machine learning model. A second set of risk scores are also calculated for individual actors (payors and/or payees involved in transactions) in a second machine learning model. Then, ensemble machine learning is used to determine overall risk scores based on the first set of risk scores and second set of risk scores.

The method for modifying an existing AML rule by reducing false alerts may include sharing the overall risk scores, the first set of transaction data, and the first set of non-transaction data with at least one entity through private blockchain. For example, method 1300 includes sharing the overall risk scores, the first set of transaction data, and the first set of non-transaction data with at least one entity through private blockchain (operation 1306). The information provided by one financial institution about a customer may be a piece of a puzzle of relationships between other actors (which may be individuals/entities holding accounts in financial institutions) connected to transactions involving the same customer. Putting together information from multiple financial institutions into an updated knowledge graph can reveal hopping transactions, as discussed in more detail below. Furthermore, information from multiple financial institutions can also be used for data augmentation. In other words, information from a first bank may help a second bank determine information missing from the second bank's knowledge graph (e.g., an unidentified node).

The method for modifying an existing AML rule by reducing false alerts may include receiving from the at least one entity through private blockchain, a second set of transaction data related to a second set of transactions each involving a payor and a payee and a second set of non-transaction data related to at least one payor and/or at least one payee involved in at least one of the second set of transactions. For example, method 1300 includes receiving from the at least one entity through private blockchain, a second set of transaction data related to a second set of transactions each involving a payor and a payee and a second set of non-transaction data related to at least one payor and/or at least one payee involved in at least one of the second set of transactions (operation 1308).

The method for modifying an existing AML rule by reducing false alerts may include updating the knowledge graph with the second set of transaction data and the second set of non-transaction data. For example, method 1300 includes updating the knowledge graph with the second set of transaction data and the second set of non-transaction data (operation 1310).

The method for modifying an existing AML rule by reducing false alerts may include using the updated knowledge graph to identify hopping transactions in which money is transferred from an initial payor to a final payee through at least one intermediary transaction involving different financial institutions and/or actors other than the first payor and the first payee, the actors acting as payors and/or payees in the intermediary transactions. For example, method 1300 includes using the updated knowledge graph to identify hopping transactions in which money is transferred from an initial payor to a final payee through at least one intermediary transaction involving different financial institutions and/or actors other than the first payor and the first payee, the actors acting as payors and/or payees in the intermediary transactions (operation 1312).

The method for modifying an existing AML rule by reducing false alerts may include, for at least one account holder, calculating a degree of separation between the account holder and an initial payor, final payee, or actor involved in at least one hopping transaction. For example, method 1300 includes, for at least one account holder, calculating a degree of separation between the account holder and an initial payor, final payee, or actor involved in at least one hopping transaction (operation 1314).

Grouping actors into communities of actors having similar behavior patterns can help with calculating a risk score for an actor (e.g., account holder). To find communities of actors having similar behavior patterns, multiple bipartite adjacency matrices may be created from the transaction data stored within the knowledge graph. For example, in some embodiments, a bipartite adjacency matrix may include one set of vertices including payors (e.g., account holders sending payments) and payees (e.g., account holders receiving payments). Below, Table 1 shows a bipartite adjacency matrix according to an embodiment.

TABLE 1
Bipartite Adjacency Matrix

| | Customer | Customer | Customer | Customer |
|---|---|---|---|---|
| | 2000 | 2001 | 2002 | 2003 |
| Party0006 | 94779 | | | |
| Party0007 | | 82172 | | |
| Party0008 | | | 113936 | |
| Party0009 | | | | 114349 |

In Table 1, the account holders sending payments are customers and the account holders receiving payments are parties. In some embodiments, since most financial institutions facilitate transactions made by their own account holders, the majority of the information the financial institution will have immediate access to is the information related to their own account holders. In embodiments where a transaction is made between two account holders from the same financial institution (e.g., first account holder (payor) in a financial institution transfers/pays money to a second account (payee) holder in the same financial institution), the financial institution will have access to information about both account holders. In comparison, in an embodiment in which a first account holder in a first financial institution transfers/pays money to a second account holder in a second financial institution, the first financial institution may not have as much information about the second account holder as the first account holder. Also, the second financial institution may not have as much information about the first account holder as the second account holder. In some embodiments, non-transaction data of one or both of the payor or payee may be added to the bipartite adjacency matrices.

In some embodiments, the process of finding communities may further include converting the multiple bipartite adjacency matrices into bipartite graphs (or subgraphs) with party and customer numbers as nodes. Edges of the bipartite graphs may include relationships, such as number of transactions, transaction amount, transaction type, and location. The subgraphs may be stored in the knowledge graph server. Subgraphs and their nodes and edges may be extracted through the graph API.

In some embodiments, the process of finding communities may further include using a community detection technique, such as the Girvan-Newman algorithm, to detect communities of actors with similar behavior within the bipartite graphs. This technique may be used to identify a first set of communities including payors and a second set of communities including payees. Each community of the first and second sets of communities may include individuals and/or entities with similar behavior.

In embodiments in which the Girvan-Newman algorithm is used, the betweenness centrality of edges within the subgraphs are found. Then, the edge with the highest betweenness are removed. Then, the betweenness centrality is recalculated with the edges removed. This process is repeated until no edges remain and the communities in the form of community networks become apparent.

The method for modifying an existing AML rule by reducing false alerts may include, for the at least one account holder, determining a context score based on the account holder's overall risk score and degree of separation. Method 1300 includes, for the at least one account holder, determining a context score based on the account holder's overall risk score and degree of separation (operation 1316). As mentioned above, the context score of a transaction may be based on an overall risk score calculated for an account holder involved in the transaction (which is based on transaction and non-transaction data related to the account holder), as well as the account holder's connection to a hopping transaction. To calculate a context score of an actor, communities of actors having similar behavior patterns may be identified within the knowledge graph. A first set of risk scores may be calculated for these communities in a first machine learning model. A second set of risk scores may also be calculated for individual actors (payors and/or payees involved in transactions) in a second machine learning model. Then, ensemble machine learning may be used to determine overall risk scores based on the first set of risk scores and second set of risk scores.

In some embodiments, the risk scores for the communities may be determined by weights of the community graph divided by the weights of all edges of whole graphs. The weights can be, for example, transaction amount, location, number of transactions, or a combination thereof.

Below, Table 2 shows risk scores for a community according to an embodiment.

TABLE 2
Community Risk Score from Community

| Payor ID | Community | Score |
|---|---|---|
| Customer2000 | Green | 0.34 |
| Customer2001 | Green | 0.34 |
| Customer2002 | Green | 0.34 |
| Customer2003 | Red | 0.75 |

Below, Table 3 shows risk scores for a community according to an embodiment.

TABLE 3
Risk Score from Community at Number of
Transactions, Location, and Transaction Amount

| | No of | Txn | Txn | | |
|---|---|---|---|---|---|
| Payor ID | Txns | Amount | Type | Location | Score |
| Customer2000 | Red | Red | Green | Red | 0.75 |
| Customer2001 | Red | Green | Red | Red | 0.65 |
| Customer2002 | Red | Green | Red | Green | 0.34 |
| Customer2003 | Green | Red | Green | Red | 0.75 |

In such an embodiment, red represents 75-100%, green represents 50-74%, yellow represents 25-49%, and green represents 0-24%. These percentages represent the likelihood of money laundering. Below, Table 4 shows risk scores for payors based on communities of payors according to an embodiment.

TABLE 4
Risk Score for Payors

| Payor ID | Risk Score |
|---|---|
| Customer2000 | 0.67 |
| Customer2001 | 0.45 |
| Customer2002 | 0.76 |
| Customer2003 | 0.87 |
| Customer2004 | 0.12 |
| Customer2005 | 0.89 |

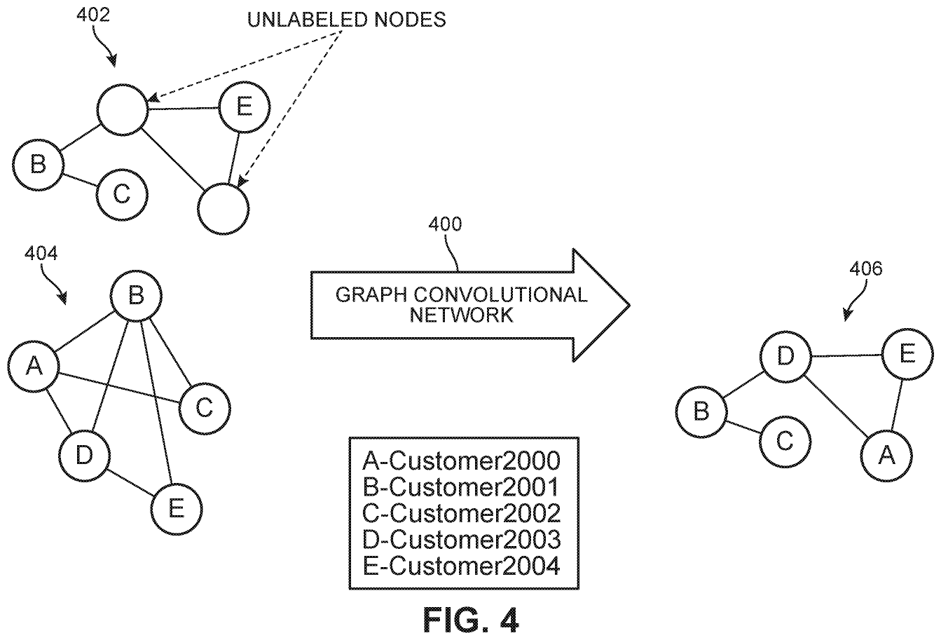

To augment missing data (e.g., new account holder identities), the community networks are inputted into a graph convolutional network (GCN). FIG. 4 illustrates how missing information may be imputed using a GCN according to an embodiment. A first subgraph 402 containing nodes labeled as B, C, and E, as well as two unlabeled nodes, is inputted into a GCN 400. A second subgraph 404 containing labeled nodes B, C, and E, as well as labeled nodes C and D is also inputted into a GCN 400. GCN 400 can output subgraph 406, which is the same as first subgraph 402 but with the unlabeled nodes labeled as A and D. The output is fed back into the knowledge graph for storage and retrieval. It is understood that A corresponds with Customer2000, B corresponds with Customer2001, C corresponds with Customer2002, D corresponds with Customer2003, and E corresponds with Customer2004 in FIG. 4. Data may be augmented through various stages of the disclosed method, as new information is obtained, analyzed, or revealed. Covariate shift may be used for data augmentation at any suitable stage.

To calculate risk scores for actors, a relational database may be built from the information contained within the knowledge graph. An analytical base table may then be created from the relational database. For example, hive scripting may be used to create an analytical base table. The analytical base table may include payors and/or payees as the subject. The analytical base table may be fed into a reinforcement learning model (e.g., deep Q learning model) to predict a risk score for each customer based on past SAR's. Below, Table 5 shows risk scores for payors based on individual payors according to an embodiment.

TABLE 5
Risk Score from Payors

| Customer ID | Risk Score |
|---|---|
| Customer2000 | 0.67 |
| Customer2001 | 0.45 |
| Customer2002 | 0.76 |
| Customer2003 | 0.87 |
| Customer2004 | 0.12 |
| Customer2005 | 0.89 |

Below, Table 6 shows overall risk scores for payors resulting from ensemble learning using risk scores from Table 4 and Table 5 according to an embodiment.

TABLE 6
Overall Risk Score from Payors

| Customer ID | Risk Score |
|---|---|
| Customer2000 | 0.69 |
| Customer2001 | 0.55 |
| Customer2002 | 0.59 |
| Customer2003 | 0.65 |
| Customer2004 | 0.17 |
| Customer2005 | 0.94 |

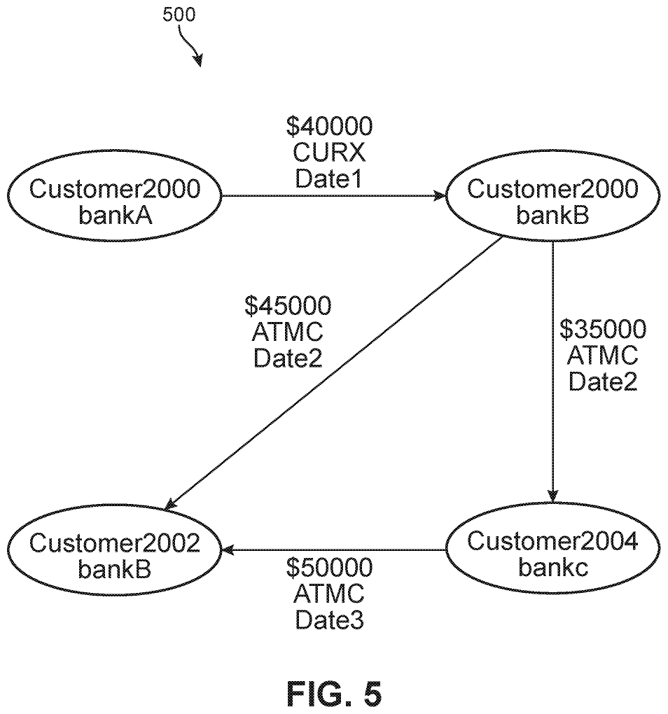

A hopping transaction is typically a transaction in which money is transferred from an initial payor to a final payee through at least one intermediary transaction involving different financial institutions and/or actors other than the first payor and the first payee. In hopping transactions, the actors can act as payors and/or payees in the initial, intermediary, and final transactions. FIG. 5 shows an example of a hopping transaction 500. In this example, the account holders are called Customer 2000, Customer 2002, and Customer 2004. Customer 2000 has an account at Bank A and Bank B. Customer 2002 has an account at Bank B. Customer 2004 has an account at Bank C. In hopping transaction 500, Customer 2000 makes an initial transaction in which Customer 2000 transfers $4,000 from Bank A to the other account Customer 2000 has at Bank B. Then, Customer 2000 makes intermediary transactions in which Customer 2000 transfers $35,000 from their account at Bank B to Customer 2004 at Bank C and also transfers $45,000 from Bank B to Customer 2002 at Bank B. Customer 2004 also makes an intermediary transaction in which Customer 2004 transfers $50,000 from their account at Bank C to Customer 2002 at Bank B. In this example, Customer 2000 can be considered the initial payor and Customer 2002 can be considered the final payee. Due to the number of account holders, transaction amounts, number of transactions, and number of banks involved in hopping transaction 300, it is difficult to track where the money is going to and from. For example, if Customer 2002 is a drug dealer and Customer 2000 is a customer of the drug dealer paying Customer 2002 $60,000, it would be difficult to glean that relationship from hopping transaction 300, as the ultimate transaction of $60,000 from Customer 2000 to Customer 2002 is hidden by the other transactions surrounding it.

Determining the context score of a transaction may include calculating a degree of separation between an account holder involved in the transaction in interest and a hopping transaction. For example, in some embodiments, this degree of separation may be calculated using Dijkstra's Algorithm to determine the distance between nodes (e.g., payors and/or payees). This degree of separation can indicate an account holder's connection to a hopping transaction.

As mentioned above, the context score is based on the overall risk score calculated for an account holder based on transaction and non-transaction data related to the account holder, as well as the account holder's connection to a hopping transaction (e.g., flag account). For example, in some embodiments, context score=sum(normalized risk score, normalized dist(flag account, normalized community risk score).

The method for modifying an existing AML rule by reducing false alerts may include using the context scores, historical alert data, one or both of the first and second transaction data, and one or both of the first and second non-transaction data to calculate the false positive likelihood of alerts generated by the existing anti-money laundering system. For example, method 1300 includes using the context scores, historical alert data, one or both of the first and second transaction data, and one or both of the first and second non-transaction data to calculate the false positive likelihood of alerts generated by the existing anti-money laundering system (operation 1318).

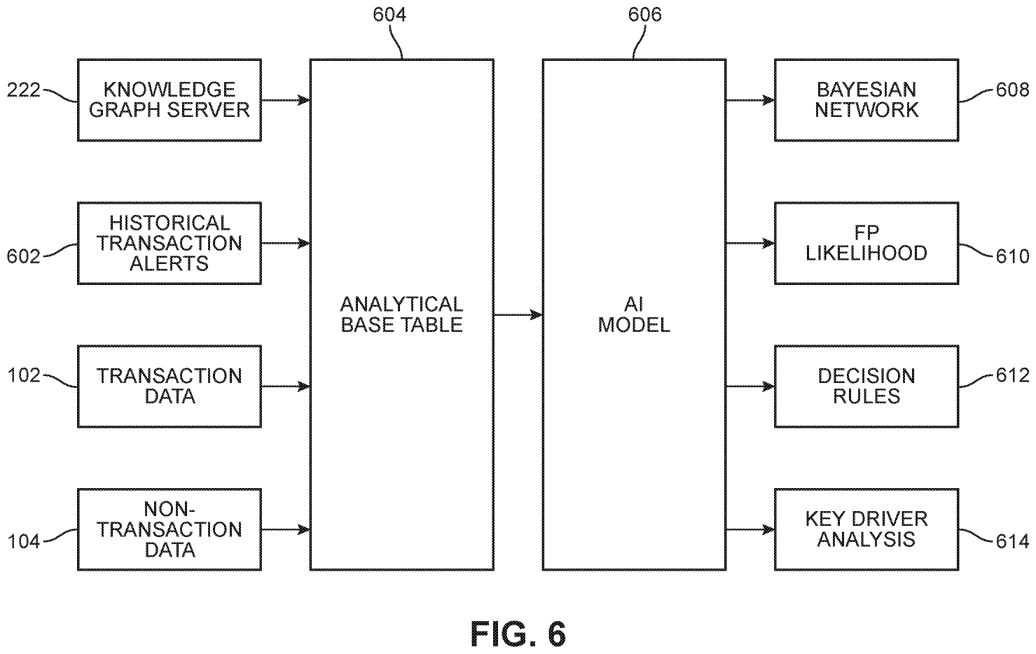

FIG. 6 shows the overall inputs and outputs related to finding and testing new thresholds for existing AML rules according to an embodiment. During this phase of the method, the inputs including the data from knowledge graph server 222, historical transaction alerts 602, transaction data 102, and non-transaction data 104 are inputted into an analytical base table 604. For example, in some embodiments, the risk score of the payor and/or payee, historical alert data, transaction data, and/or non-transaction data may be used to create the analytical base table. In some embodiments, the analytical base table may be used to create an artificial intelligence model (e.g., classification model). For example, as shown in FIG. 6, analytical base table 604 is used to create an artificial intelligence model 606 that outputs a Bayesian network 608, a false positive alert likelihood 610, decision rules 612, and key driver analysis 614.

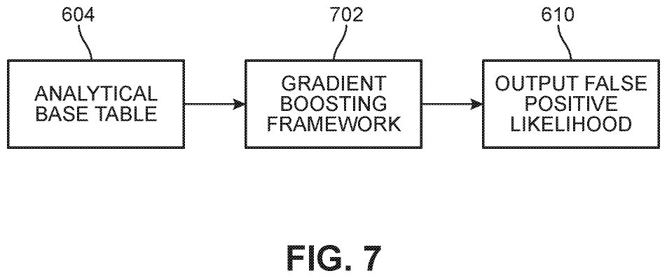

The independent variables of the analytical base table may include alert information, such as alert number, alert assignment date, alert type code, alert priority, customer number, triggering transaction, Bnumber of party, transaction type, transaction amount, method of transaction, etc. The dependent variables of the model may be status of an alert as SAR or case. A library that provides a gradient boosting framework (e.g., XGBoost, which is a decision-tree-based ensemble Machine Learning algorithm) may be used to predict the likelihood of a false positive alert. For example, as shown in FIG. 7, analytical base table 604 is inputted into a gradient boosting framework 702 and false positive likelihood output 610 is outputted. The false positive likelihood output may be a probability determined through classification for each alert. Below, Table 7 shows false positive likelihood probabilities per alert determined by the gradient boosting framework according to an embodiment.

TABLE 7
False Positive Likelihood

| Alert | False Positive |
|---|---|
| Number | Probability |
| 1000 | 0.04 |
| 1001 | 0.03 |
| 1002 | 0.05 |
| 1003 | 0.41 |
| 1004 | 0.5 |
| 1005 | 0.25 |

In boosting, models may be added sequentially until no further improvement is possible in the models. In gradient, new models may be created that predict the residuals/errors of previous models and then models which are in sequence are added together to make the final prediction. XGBoost is a boosted tree distributed computational technique that optimizes memory. XGBoost allows parallel tree construction using all cores of a central processing unit (CPU) and a graphics processing unit (GPU). XGBoost also supports distributed and out-of-core computing for training large datasets. The cache optimization of XGBoost improves training speed.

The method for modifying an existing AML rule by reducing false alerts may include using the context scores, historical alert data, one or both of the first and second transaction data, and one or both of the first and second non-transaction data to perform a key driver analysis to determine factors impacting the false positive likelihood of the alerts. For example, method 1300 includes using the context scores, historical alert data, one or both of the first and second transaction data, and one or both of the first and second non-transaction data to perform a key driver analysis to determine factors impacting the false positive likelihood of the alerts (operation 1320).

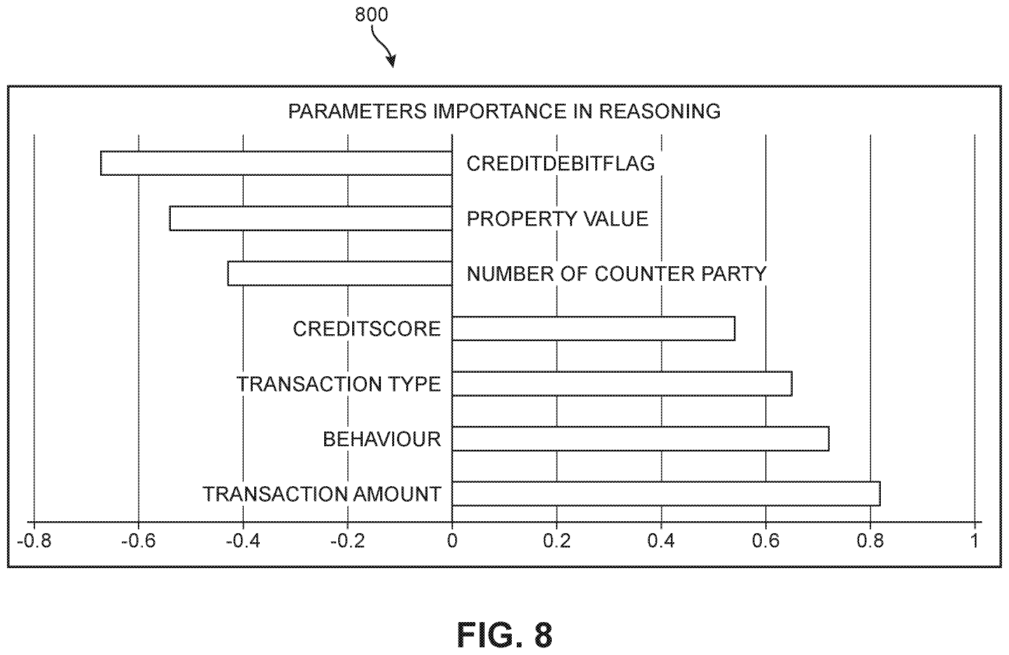

To perform a key driver analysis, in some embodiments, a wrapper may be used with the gradient boosting framework. In such embodiments, the wrapper may use a greedy search method to identify the set of features. The gradient boosting framework may provide a score of every feature, which represents relative importance of every feature. The scores can be used to compare attributes and to rank variables. For example, FIG. 8 shows the feature importance resulting from the key driver analysis. The features shown in FIG. 8 include non-transaction data, such as credit/debit flag, property value, number of counter party, number of counter party, credit score, and behavior. The features shown in FIG. 8 also include transaction data, such as transaction type and transaction amount. In FIG. 8, transaction amount impacts false positive cases more than transaction type. This analysis result can indicate that the transaction type should be tuned in the existing AML rule.

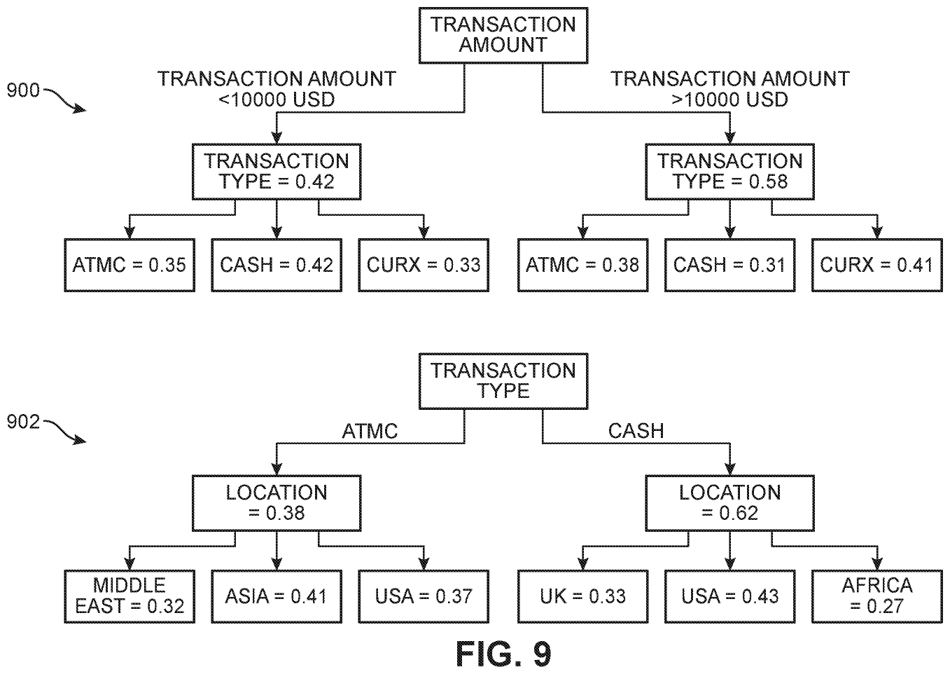

The method for modifying an existing AML rule by reducing false alerts may include using the results of the key driver analysis with a decision tree method to create decision rules and to determine new threshold values for the existing anti-money laundering rule. For example, method 1300 includes using the results of the key driver analysis with a decision tree method to create decision rules and to determine new threshold values for the existing anti-money laundering rule (operation 1322). In some embodiments, a decision tree may be created on the analytical base table of alert information to determine decision rules and thresholds for the existing AML rules. For example, FIG. 9 shows a first decision tree 900 based on transaction amount and a second decision tree 902 based on transaction type. A top down approach may be used while creating the decision trees. A first root node may be identified using an entropy calculation. The highest impurity variable may be selected as the root node and data may be partitioned into subsets with similar value instances. This homogeneity may be calculated using the entropy. Decision rules may be created from root and leaves of the decision tree. Decision trees and decision rules may be used to create rule thresholds. Thresholds may be obtained from the leaf nodes of trees.

The thresholds determined at the leaf nodes of the decision trees may be shared with consortium (e.g., financial institutions) over private blockchain. Other information shared via private blockchain may include one or more of the AML system name (e.g., Actimize, FRCM, SAS AML), rule ID, number of transactions, status as SAR or case, number of alerts, alert suppression (if present), SAR/case ratio, and case to alert ratio.

Once the above-mentioned information is shared over blockchain, a relevancy score may be calculated at the master node of the blockchain using listwise learning to rank the algorithm at each rule. This technique of ranking rules optimizes the value of one of the above evaluation measures, averaged over all queries in the training data. The relevancy rank may be shared at every node of the private blockchain. Table 8 below shows rule level data along with the relevancy score of the rules according to an embodiment.

TABLE 8
Relevancy Rank

| | | | | Txn | | | Txn | Relevancy |
|---|---|---|---|---|---|---|---|---|
| BankID | Product | RuleID | Amount | Type | Location | Duration | Count | Rank |
| Bank1 | Actimize | Abc1 | 15000 | ATMC | US | 12 | 5 | 1 |
| Bank2 | Actimize | Abc1 | 15000 | ATMC | US | 14 | 3 | 2 |
| Bank3 | Actimize | Abc1 | 15000 | ATMC | US | 14 | 4 | 3 |
| Bank4 | FRCM | Lmn1 | 15000 | ATMC | US | 14 | 3 | 4 |

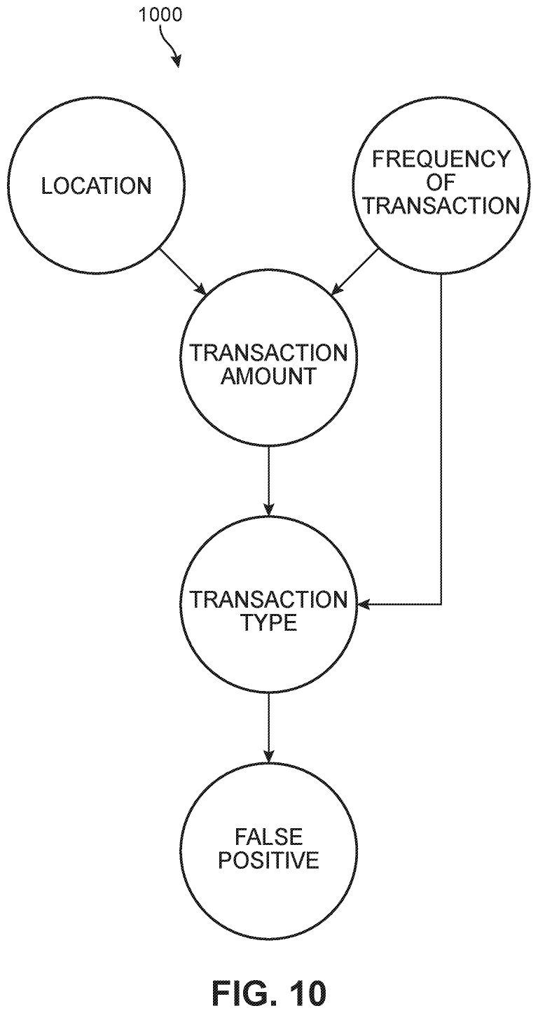

The system and method may include a Bayesian network that can perform Bayesian scoring of constraints (BSC) to get a directed acyclic graph (DAG) and to find the causality. For example, FIG. 10 shows a DAG 1000 created using BSC. In BSC, many structures are learned and then one ensemble is created from the all structures. Once a DAG is constructed, D-separation may be used to identify the flow of influences. There are two main types of connections: direct and indirect connections. Four types of indirect connections include indirect causal relationship, indirect evidential relationship, common cause relationship, and common effect relationship. Conditional probability distribution (CPD) tables may be created from the Bayesian network. Table 9 below shows the CPD corresponding to transaction location according to an embodiment.

TABLE 9
CPD for Location Transaction

| Location | Probability |
|---|---|
| Middle East | 0.2 |
| Africa | 0.05 |
| Asia | 0.15 |
| Australia | 0.05 |
| North America | 0.45 |
| South America | 0.1 |

Table 10 below shows CPD corresponding to transaction frequency according to an embodiment.

TABLE 10
CPD for Transaction Frequency

| No. of Txn | Probability |
|---|---|
| High | 0.3 |
| Medium | 0.25 |
| Low | 0.45 |

Table 11 below shows CPD for transaction amount for a high transaction frequency according to an embodiment. A similar table may be constructed for low and medium transaction frequencies.

TABLE 11
CPD for Transaction Amount for High Transaction Frequency

| | Middle | | | North | South |
|---|---|---|---|---|---|
| Txn Amt | East | Africa | Australia | America | America |
| <2000 | 0.1 | 0.1 | 0.1 | 0.1 | 0.1 |
| 2000-10000 | 0.2 | 0.2 | 0.2 | 0.2 | 0.2 |
| 10000-20000 | 0.1 | 0.1 | 0.1 | 0.1 | 0.1 |
| 20000-50000 | 0.01 | 0.01 | 0.01 | 0.01 | 0.01 |
| 50000+ | 0.23 | 0.23 | 0.23 | 0.23 | 0.23 |

Table 12 below shows CPD for transaction type for a high transaction frequency according to an embodiment. A similar table may be constructed for low and medium transaction frequencies.

TABLE 12
CPD for Transaction Type for a High Transaction Frequency

| Txn Type | <2000 | 2000-10000 | 2000-10000 | 10000-20000 | 20000-50000 | 50000+ |
|---|---|---|---|---|---|---|
| CASH | 0.1 | 0.1 | 0.1 | 0.1 | 0.1 | 0.1 |
| ATMC | 0.2 | 0.2 | 0.2 | 0.2 | 0.2 | 0.2 |
| CURX | 0.1 | 0.1 | 0.1 | 0.1 | 0.1 | 0.1 |
| BNKC | 0.01 | 0.01 | 0.01 | 0.01 | 0.01 | 0.01 |
| DBTC | 0.23 | 0.23 | 0.23 | 0.23 | 0.23 | 0.23 |

Table 13 below shows CPD for false positive alerts classified as SAR or case corresponding to transaction type according to an embodiment.

TABLE 13
CPD for False Positive Alerts

| False | | | | | |
|---|---|---|---|---|---|
| Positive Alert | CASH | ATMC | CURX | BNKC | DBTC |
| SAR | 0.1 | 0.1 | 0.1 | 0.1 | 0.1 |
| Cases | 0.2 | 0.2 | 0.2 | 0.2 | 0.2 |

The DAG and CPD tables can help with determining indirect causal relationships.

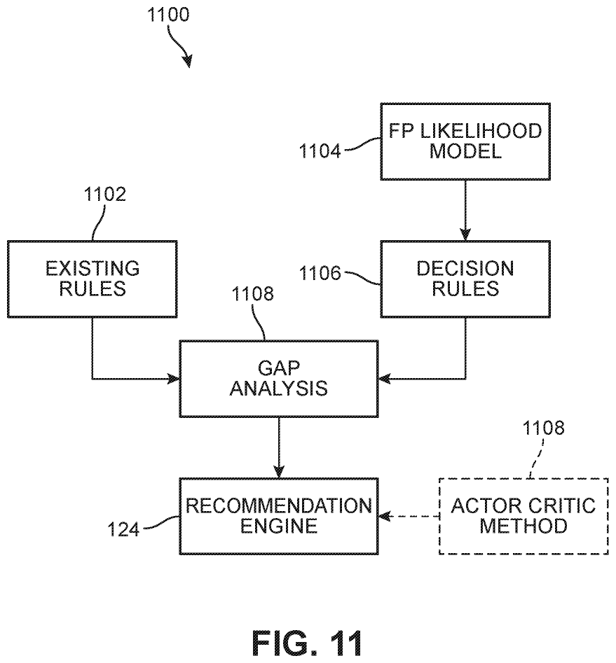

FIG. 11 shows the general flow of analysis that leads to a recommendation for threshold values according to an embodiment. The flow of analysis includes false positive likelihood model 1104, decision rules 1106, existing rules 1102, gap analysis 1108, actor critic method 1112, and recommendation engine 124. The false positive likelihood model may include a model that uses the data from the knowledge graph to determine false positive likelihood probabilities (e.g., probabilities in Table 7). For example, analytical base table 604 and gradient boosting framework 702 may together form a false positive likelihood model. The analysis from the false positive likelihood model may used by a decision tree to make decision rules 1106 and to determine thresholds in the manner discussed above.

The method for modifying an existing AML rule by reducing false alerts may include performing a gap analysis using a what-if simulation with the new threshold values and the decision rules to determine a difference between performance of existing anti-money laundering rules and anti-money laundering rules modified with the new threshold values. For example, method 1300 includes performing a gap analysis using a what-if simulation with the new threshold values and the decision rules to determine a difference between performance of existing anti-money laundering rules and anti-money laundering rules modified with the new threshold values (operation 1324). A gap analysis is shown according to an embodiment in FIG. 11 as existing rules 1102 from an existing AML software system is compared with decision rules 1106 in a gap analysis 1108.

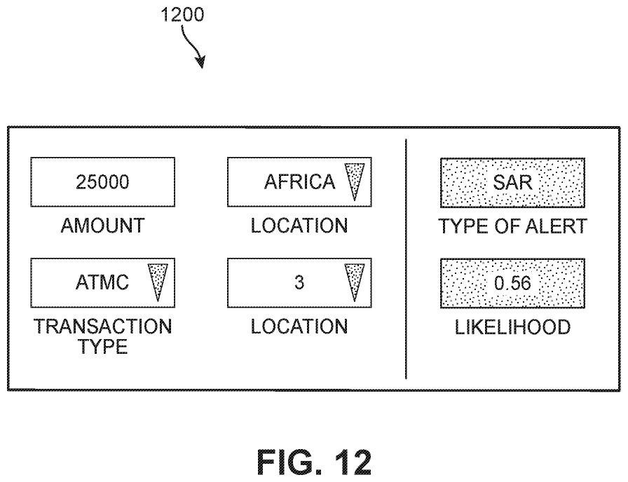

The gap analysis may be performed using a what-if simulation with the new threshold values and the decision rules to determine difference between performance of existing AML rules and AML rules modified with the new threshold values. It is understood that the gap analysis may be performed for one or more existing rules. FIG. 12 illustrates results of a what-if simulation according to an embodiment. The results of the gap analysis may be used as input for a recommendation engine to determine a recommendation for modifying the existing AML rule. AI model 606 may create and analyze the gap at a rule level and may further tune the existing rules. An actor critic method may be used to check and improve the performance of the recommendation engine. Actor critic is temporal difference method in which the recommendation engine is known as the actor and estimated value function is known as the critic.

Table 14 below shows results from the actor critic method according to an embodiment.

TABLE 14
Results of Actor Critic Method

| Policy | State | Value |
|---|---|---|
| (AML Rule) | (thresholds) | Function |
| AML rule1 | 12000, ATMC, 3 | 0.34 |
| AML rule2 | 5000, CRUX, 4 | 0.45 |
| AML rule1 | 2000, ATMC, 3 | 0.54 |

The method for modifying an existing AML rule by reducing false alerts may include using reinforcement learning to determine a recommendation for modifying the existing anti-money laundering rule. For example, method 1300 includes using reinforcement learning to determine a recommendation for modifying the existing anti-money laundering rule (operation 1326). The recommendation engine may be used in scenario optimization and performance improvement of the existing AML system. The recommendation engine may compare the existing rules using the thresholds with the existing rules with their initial thresholds. The recommendation engine may use the results of the comparison to determine a recommendation to modify an existing rule of an AML software system. The recommendation engine may send the recommendation to the existing system. In some embodiments, the method for modifying an existing AML rule by reducing false alerts may include modifying the existing AML rule according to the recommendation.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A method for modifying an existing anti-money laundering rule of an existing anti-money laundering system to reduce false alerts, the method comprising:
building a knowledge graph with a first set of transaction data related to a first set of transactions each involving a payor and a payee, a first set of non-transaction data related to at least one payor and/or at least one payee involved in at least one of the first set of transactions, and a plurality of historical alerts each corresponding to a transaction of the first set of transactions;
using machine learning to determine overall risk scores for account holders based on the first set of transaction data and the first set of non-transaction data, wherein the account holders are payors and/or payees involved in the first set of transactions;
sharing the overall risk scores, the first set of transaction data, and the first set of non-transaction data with at least one entity through private blockchain;
from the at least one entity through private blockchain, receiving a second set of transaction data related to a second set of transactions each involving a payor and a payee and a second set of non-transaction data related to at least one payor and/or at least one payee involved in at least one of the second set of transactions;
updating the knowledge graph with the second set of transaction data and the second set of non-transaction data;
using the updated knowledge graph to identify hopping transactions in which money is transferred from an initial payor to a final payee through at least one intermediary transaction involving different financial institutions and/or actors other than the first payor and the first payee, the actors acting as payors and/or payees in the intermediary transactions;
for each account holder, calculating a degree of separation between the account holder and an initial payor, final payee, or actor involved in at least one hopping transaction;
for each account holder, determining a context score based on the account holder's overall risk score and degree of separation;
using the context scores, historical alert data, one or both of the first and second transaction data, and one or both of the first and second non-transaction data to calculate the false positive likelihood of alerts generated by the existing anti-money laundering system;
using the context scores, historical alert data, one or both of the first and second transaction data, and one or both of the first and second non-transaction data to perform a key driver analysis to determine factors impacting the false positive likelihood of the alerts;
using the results of the key driver analysis with a decision tree method to create decision rules and to determine new threshold values for the existing anti-money laundering rule;
performing a gap analysis using a what-if simulation with the new threshold values and the decision rules to determine difference between performance of existing anti-money laundering rules and anti-money laundering rules modified with the new threshold values; and
using reinforcement learning determine a recommendation for modifying the existing anti-money laundering rule.

2. The method of claim 1, wherein determining a context score based on the account holder's overall risk score and degree of separation includes using the knowledge graph to create a plurality of bipartite adjacency matrices in which a first set of vertices include payors and a second set of vertices include payees.

3. The method of claim 2, wherein determining a context score based on the account holder's overall risk score and degree of separation further includes building a plurality of bipartite graphs from the plurality of bipartite adjacency matrices.

4. The method of claim 3, wherein determining a context score based on the account holder's overall risk score and degree of separation further includes detecting a plurality of communities within the plurality of bipartite graphs.

5. The method of claim 1, wherein determining a context score based on the account holder's overall risk score and degree of separation further includes finding communities of payors and/or payees having similar behavior patterns within the knowledge graph and determining an overall risk score by using a first machine learning model to determine a first risk score for each of the plurality of communities, wherein the first risk score is calculated for each of the following types of transaction data: transaction location, transaction type, number of transactions, and transaction amount.

6. The method of claim 5, wherein determining a context score based on the account holder's overall risk score and degree of separation further includes using a second machine learning model to determine a second risk score for at least a portion of the plurality of payors and/or payees, wherein the second risk score is calculated for each of the following types of transaction data: transaction location, transaction type, number of transactions, and transaction amount, and using an ensemble model of the first and second machine learning models to determine overall risk scores for the at least a portion of the plurality of payors and/or payees.

7. The method of claim 1, wherein the payor and/or payee is one of an individual, an entity, a bank account.

8. The method of claim 1, further comprising modifying the existing anti-money laundering rule according to the recommendation.

9. A system for modifying an existing anti-money laundering rule of an existing anti-money laundering system to reduce false alerts, comprising:
one or more computers and one or more storage devices storing instructions that are operable, when executed by the one or more computers, to cause the one or more computers to:
build a knowledge graph with a first set of transaction data related to a first set of transactions each involving a payor and a payee, a first set of non-transaction data related to at least one payor and/or at least one payee involved in at least one of the first set of transactions, and a plurality of historical alerts each corresponding to a transaction of the first set of transactions;
use machine learning to determine overall risk scores for account holders based on the first set of transaction data and the first set of non-transaction data, wherein the account holders are payors and/or payees involved in the first set of transactions;
share the overall risk scores, the first set of transaction data, and the first set of non-transaction data with at least one entity through private blockchain;
from the at least one entity through private blockchain, receive a second set of transaction data related to a second set of transactions each involving a payor and a payee and a second set of non-transaction data related to at least one payor and/or at least one payee involved in at least one of the second set of transactions;
update the knowledge graph with the second set of transaction data and the second set of non-transaction data;
use the updated knowledge graph to identify hopping transactions in which money is transferred from an initial payor to a final payee through at least one intermediary transaction involving different financial institutions and/or actors other than the first payor and the first payee, the actors acting as payors and/or payees in the intermediary transactions;
for each account holder, calculate a degree of separation between the account holder and an initial payor, final payee, or actor involved in at least one hopping transaction;
for each account holder, determine a context score based on the account holder's overall risk score and degree of separation;
use the context scores, historical alert data, one or both of the first and second transaction data, and one or both of the first and second non-transaction data to calculate the false positive likelihood of alerts generated by the existing anti-money laundering system;
use the context scores, historical alert data, one or both of the first and second transaction data, and one or both of the first and second non-transaction data to perform a key driver analysis to determine factors impacting the false positive likelihood of the alerts;
use the results of the key driver analysis with a decision tree method to create decision rules and to determine new threshold values for the existing anti-money laundering rule;
perform a gap analysis using a what-if simulation with the new threshold values and the decision rules to determine difference between performance of existing anti-money laundering rules and anti-money laundering rules modified with the new threshold values; and
use reinforcement learning determine a recommendation for modifying the existing anti-money laundering rule.

10. The system of claim 9, wherein determining a context score based on the account holder's overall risk score and degree of separation includes using the knowledge graph to create a plurality of bipartite adjacency matrices in which a first set of vertices include payors and a second set of vertices include payees.

11. The system of claim 10, wherein determining a context score based on the account holder's overall risk score and degree of separation further includes building a plurality of bipartite graphs from the plurality of bipartite adjacency matrices.

12. The system of claim 11, wherein determining a context score based on the account holder's overall risk score and degree of separation further includes detecting a plurality of communities within the plurality of bipartite graphs.

13. The system of claim 9, wherein determining a context score based on the account holder's overall risk score and degree of separation further includes finding communities of payors and/or payees having similar behavior patterns within the knowledge graph and determining an overall risk score by using a first machine learning model to determine a first risk score for each of the plurality of communities, wherein the first risk score is calculated for each of the following types of transaction data: transaction location, transaction type, number of transactions, and transaction amount.

14. The system of claim 13, wherein determining a context score based on the account holder's overall risk score and degree of separation further includes using a second machine learning model to determine a second risk score for at least a portion of the plurality of payors and/or payees, wherein the second risk score is calculated for each of the following types of transaction data: transaction location, transaction type, number of transactions, and transaction amount, and using an ensemble model of the first and second machine learning models to determine overall risk scores for the at least a portion of the plurality of payors and/or payees.

15. The system of claim 9, wherein the payor and/or payee is one of an individual, an entity, a bank account.

16. The system of claim 9, further comprising modifying the existing anti-money laundering rule according to the recommendation.

17. A non-transitory computer-readable medium storing software comprising instructions executable by one or more computers which, upon such execution, cause the one or more computers to:
build a knowledge graph with a first set of transaction data related to a first set of transactions each involving a payor and a payee, a first set of non-transaction data related to at least one payor and/or at least one payee involved in at least one of the first set of transactions, and a plurality of historical alerts each corresponding to a transaction of the first set of transactions;
use machine learning to determine overall risk scores for account holders based on the first set of transaction data and the first set of non-transaction data, wherein the account holders are payors and/or payees involved in the first set of transactions;
share the overall risk scores, the first set of transaction data, and the first set of non-transaction data with at least one entity through private blockchain;
from the at least one entity through private blockchain, receive a second set of transaction data related to a second set of transactions each involving a payor and a payee and a second set of non-transaction data related to at least one payor and/or at least one payee involved in at least one of the second set of transactions;
update the knowledge graph with the second set of transaction data and the second set of non-transaction data;
use the updated knowledge graph to identify hopping transactions in which money is transferred from an initial payor to a final payee through at least one intermediary transaction involving different financial institutions and/or actors other than the first payor and the first payee, the actors acting as payors and/or payees in the intermediary transactions;
for each account holder, calculate a degree of separation between the account holder and an initial payor, final payee, or actor involved in at least one hopping transaction;
for each account holder, determine a context score based on the account holder's overall risk score and degree of separation;
use the context scores, historical alert data, one or both of the first and second transaction data, and one or both of the first and second non-transaction data to calculate the false positive likelihood of alerts generated by the existing anti-money laundering system;
use the context scores, historical alert data, one or both of the first and second transaction data, and one or both of the first and second non-transaction data to perform a key driver analysis to determine factors impacting the false positive likelihood of the alerts;
use the results of the key driver analysis with a decision tree method to create decision rules and to determine new threshold values for the existing anti-money laundering rule;
perform a gap analysis using a what-if simulation with the new threshold values and the decision rules to determine difference between performance of existing anti-money laundering rules and anti-money laundering rules modified with the new threshold values; and
use reinforcement learning determine a recommendation for modifying the existing anti-money laundering rule.

18. The non-transitory computer-readable medium storing software of claim 17, wherein determining a context score based on the account holder's overall risk score and degree of separation includes:
using the knowledge graph to create a plurality of bipartite adjacency matrices in which a first set of vertices include payors and a second set of vertices include payees; and
building a plurality of bipartite graphs from the plurality of bipartite adjacency matrices.

19. The non-transitory computer-readable medium storing software of claim 17, wherein determining a context score based on the account holder's overall risk score and degree of separation further includes finding communities of payors and/or payees having similar behavior patterns within the knowledge graph and determining an overall risk score by using a first machine learning model to determine a first risk score for each of the plurality of communities, wherein the first risk score is calculated for each of the following types of transaction data: transaction location, transaction type, number of transactions, and transaction amount.

20. The non-transitory computer-readable medium storing software of claim 17, wherein determining a context score based on the account holder's overall risk score and degree of separation further includes using a second machine learning model to determine a second risk score for at least a portion of the plurality of payors and/or payees, wherein the second risk score is calculated for each of the following types of transaction data: transaction location, transaction type, number of transactions, and transaction amount, and using an ensemble model of the first and second machine learning models to determine overall risk scores for the at least a portion of the plurality of payors and/or payees.
